(19) United States
(12) Patent Application Publication
(10) Pub. No.: US 2012/0048478 A1
(43) Pub. Date: Mar. 1, 2012

(54) Bead Bender Systems

(76) Inventor: William McGlumphy, Punxsutawney, PA (US)

(21) Appl. No.: 13/206,514

(22) Filed: Aug. 10, 2011

Related U.S. Application Data
(60) Provisional application No. 61/377,161, filed on Aug. 26, 2010.

(51) Int. Cl. B60C 25/02

(52) U.S. Cl. 157/1.3

(57) ABSTRACT

Disclosed is a tool that is designed to spread a tire to allow for the removal and installation of a rim lock, inner tube, or valve stem during a tire change or repair. The bead bender tool can be used by bicyclists, motorcyclists, and by shop mechanics allowing users to complete tire repairs without injury to the user's fingers. The bead bender tool may be comprised of a handle having a centerline and a shank with a rounded end-tip. The shank comprises at least one but preferably two compound bends, (a first and a second 90 degree bend), and a first, second and third shank portion. First shank portion and second shank portion are perpendicularly oriented to each other and third shank portion is perpendicularly oriented with the second shank portion. Third shank portion is orientated off-set parallel to first shank portion. Third shank portion may threadably receive various lengths of fourth-shank-portions for use on various width tires.

### CROSS-REFERENCE TO RELATED APPLICATION

The present application is related to and claims priority from prior provisional application Ser. No. 61/377,161, filed Aug. 26, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of tire-working tools and more specifically relates to a tire bead working tool.

2. Description of the Related Art

Nearly all modern vehicles designed for public roads and off road use utilize rubber tires mounted on metallic or alloyed wheels or rims that are coupled to each end of the axle hubs and suspension system to provide a smooth and safe ride for the occupants. A tire is typically a U-profile, ring-shaped device that fits around a wheel rim to protect it and enable better vehicle performance by providing a flexible cushion that absorbs shock while keeping the wheel in traction and close contact with the ground. Modem rubber tires basically have a road contact surface or tread, an inner volume for pressurizing with air, a sidewall for support, and a bead.

The bead of a tire is what makes contact with the metal rim making an airtight seal when pressurized so that a cushion is created between the vehicle and the irregularities in a road surface. The tire bead has a slightly smaller inside diameter than the outside diameter of the metal rim that it is mounted on. In order to mount the rubber tire on the rim, the bead on one side of the tire must be stretched in one spot and worked 360 degrees around the rim until one side of the tire slides past the rim. This manipulation of a tire is usually done with tools made for this purpose. When the other bead of the tire has been worked past the edge of the rim completely, the tire is ready for air. Once the tire has been pressurized, the outside of the bead presses tightly against the inner edge surface of the rim thereby creating a seal.

When a tire has been punctured releasing the inner air pressure, the bead must be unseated from the rim and the tire bead manipulated until the entire bead on one side of the tire is positioned to the outside of the rim. With one side of the tire manipulated to the outside of the rim, the inside of the tire can be accessed for making repairs on the rubber inner portion of the tire or for removing a tube. On bicycle or motorcycle tires, the tire width is narrow enough to create some difficulty when making repairs. One of the issues with changing or repairing motorcycle or similar tires is that there is not a sufficient amount of room between the tire and the wheel to install and remove rim locks, inner tubes and valve stems without pinching one's fingers. It can be extremely difficult for an individual to spread the bead of a tire apart to allow for easy access. A bead spreader for use on cycle tires would provide efficiency and safety in tire repairs.

Various attempts have been made to solve the above-mentioned problems such as those found in U.S. Pat. Nos. 6,684,927; 6,712,114; 5,143,134; 5,123,470; 1,607,341; and 2,560,101. This prior art is representative of tire working tools. None of the above inventions and patents, taken either singly or in combination, is seen to describe the invention as claimed.

Ideally, a bead bender tool should provide convenience and ease of use, and yet, would operate reliably and be manufactured at a modest expense. Thus, a need exists for a reliable bead bender system to spread a tire bead while working on a cycle tire or other and to avoid the above-mentioned problems.

### BRIEF SUMMARY OF THE INVENTION

In view of the foregoing disadvantages inherent in the known tire working tool art, the present invention provides a novel bead bender (spreader) system. The general purpose of the present invention, which will be described subsequently in greater detail, is to provide greater convenience and ease of use when making tire repairs.

Disclosed herein is a tool that is designed to quickly spread apart a tire bead to allow for the removal and installation of a rim lock, inner tube and/or valve stem during a tire change or repair. This device can be used by bicycle riders, motorcycle enthusiasts, and by shop mechanics (and others) who repair and change tires. This product eases the installation and removal process of rim locks, inner tubes and valve stems and allows users to complete the task substantially preventing injury to their fingers.

The bead bender tool of the preferred embodiment may be comprised of a handle having a centerline and a shank with a rounded end-tip. The handle is non-removably attached to the shank which comprises a (substantially) Z-shaped profile for use in spreading a cycle tire for facilitating any work requiring removal of one side of the tire bead from the seated position on the rim. The shank comprises at least one, but preferably two compound bends: a first 90 degree bend and a second 90 degree bend. The shank extends from the handle along the centerline up to the first 90 degree bend. The first 90 degree bend and the second 90 degree bend are orientated to form the Z-shape(d) profile. The compound bend of the first 90 degree bend and the second 90 degree bend are orientated off-set parallel to each other (first 90 degree bend and said second 90 degree bend may be orientated off-set non-parallel to each other in other embodiments). The first 90 degree bend of the shank is perpendicularly-oriented relative to the centerline of the handle and the second 90 degree bend of the shank is perpendicularly-oriented about 20-25 degrees relative to the centerline of the handle.

The shank from the handle to the first 90 degree bend comprises a first shank-portion (first through fourth shank portions referenced for clarity), the shank between the first 90 degree bend and the second 90 degree bend comprises a second shank-portion, and the shank between the second 90 degree bend and the rounded end-tip comprises a third shank-portion. In a preferred embodiment, the third shank-portion may comprise at least one removable fourth shank-portion preferably having a milled tool-keyway whereby a wrench may be used to uncouple and/or couple the removable fourth shank-portion from a coupled relationship with the third shank-portion.

The removable fourth shank-portion(s) preferably comprise a threaded stud and the third shank-portion comprises a threaded bore for threadably-receiving the threaded stud. There may be more than one removable fourth-shank-portion of various lengths from about 1 inch to about 4 inches in length. As such, the bead bender tool is usable to spread apart a tire bead (tires of different widths—using the same tool) to allow for the removal and installation of a rim lock, inner tube, and valve stem during a cycle tire change or repair. The tool may be made of plastic, carbon fiber or virtually any suitable kind of metal alloy round stock material. The shaft may have a diameter of approximately ¼″ or 5/16″ and may be approximately 13″ including the handle in length.

Bead bender systems may be manufactured and sold as a kit comprising the following parts: at least one handle with a shank (having at least first shank-portion, second shank-portion and third shank-portion, optionally with a removable fourth shank-portion in certain embodiments); at least one spacer (which is used for additional length adjustment) of removable fourth shank-portion to third shank-portion); optionally at least one removable fourth shank-portion which is about 4 inches long; another about 3 inches long; another about 2 inches long; and at least one removable fourth shank-portion that may be about 1 inch long. Removable fourth shank-portions are suitable for manipulating a tire bead on various width tires. The kit may further comprise at least one set of user instructions.

A method of use for a bead bender system may comprise the steps of: deflating a pneumatic tire; removing a valve core; prying a tire bead over a rim outer edge; wedging open a tire with bead bender tool; repairing a tire; removing bead bender tool from the tire; reseating a tire bead on a rim; and pressurizing a tire for use.

The present invention holds significant improvements and serves as a bead bender system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, bead bender systems, constructed and operative according to the teachings of the present invention.

FIG. 1 shows a perspective view illustrating bead bender systems in an in-use condition according to an embodiment of the present invention.

FIG. 2 is a side perspective view illustrating a bead bender systems tool according to an embodiment of the present invention of FIG. 1.

FIG. 3 is a top perspective view of the bead bender systems tool according to an embodiment of the present invention of FIGS. 1 and 2.

FIG. 4 is a perspective view illustrating an alternate version of the bead bender systems tool according to another embodiment of the present invention of FIG. 1.

FIG. 5 is a flowchart illustrating a method of use for the bead bender systems according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a tire bead tool and more particularly to a tire bead spreader tool as used to improve the ease and convenience of repairing tires.

Generally speaking, bead bender systems 100 is a tool that is designed to quickly spread apart tire beads 110 (and hold in a preferred orientation relative to rim 125) to allow for the easier removal and installation of rim locks, inner tubes and valve stems during a change or repair procedure on tire 120. This device can be used by motorcycle enthusiasts who repair and change tires 120. The spreading and holding of the tire 120 allows users to complete the task without injury to the fingers.

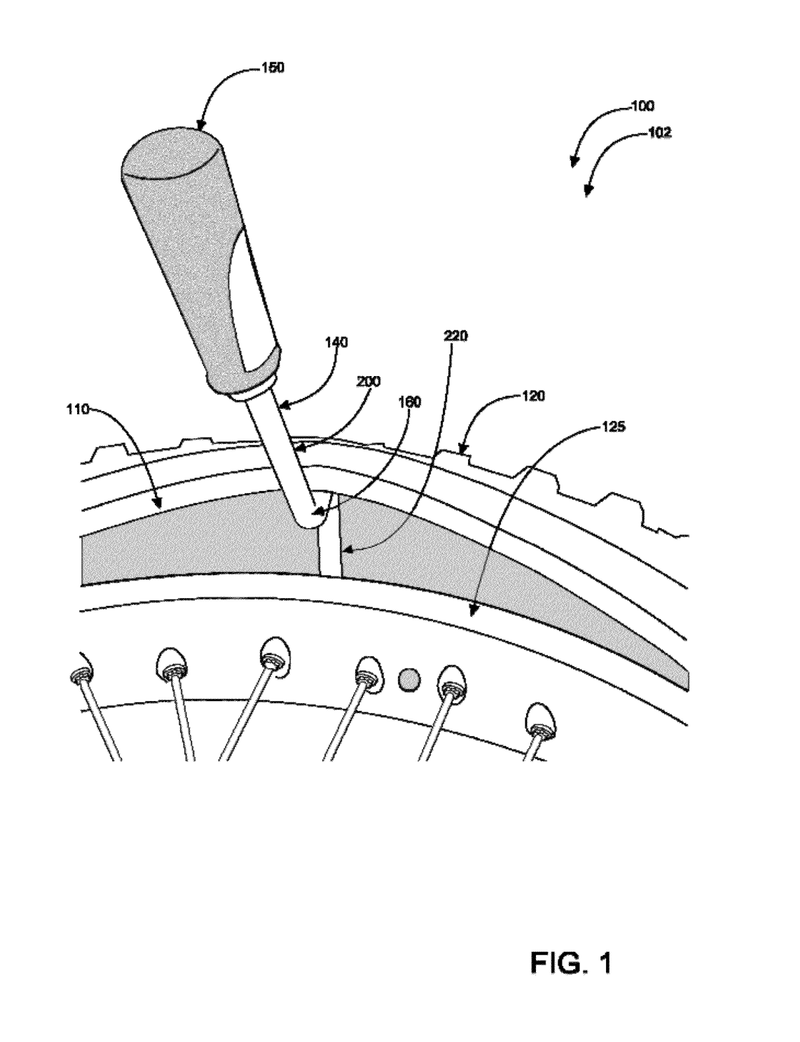

Referring now more specifically to the drawings by numerals of reference there is shown in FIG. 1, a perspective view illustrating an in-use condition of bead bender systems 100 according to an embodiment of the present invention. Bead bender systems 100 comprises a tool (bead bender tool 102) that will spread apart tire beads 110 to allow for greater ease of access to remove and install rim locks, inner tubes and valve stems. Bead bender tool 102 may be made of plastic, carbon fiber or virtually any suitable kind of metal alloy of round stock material.

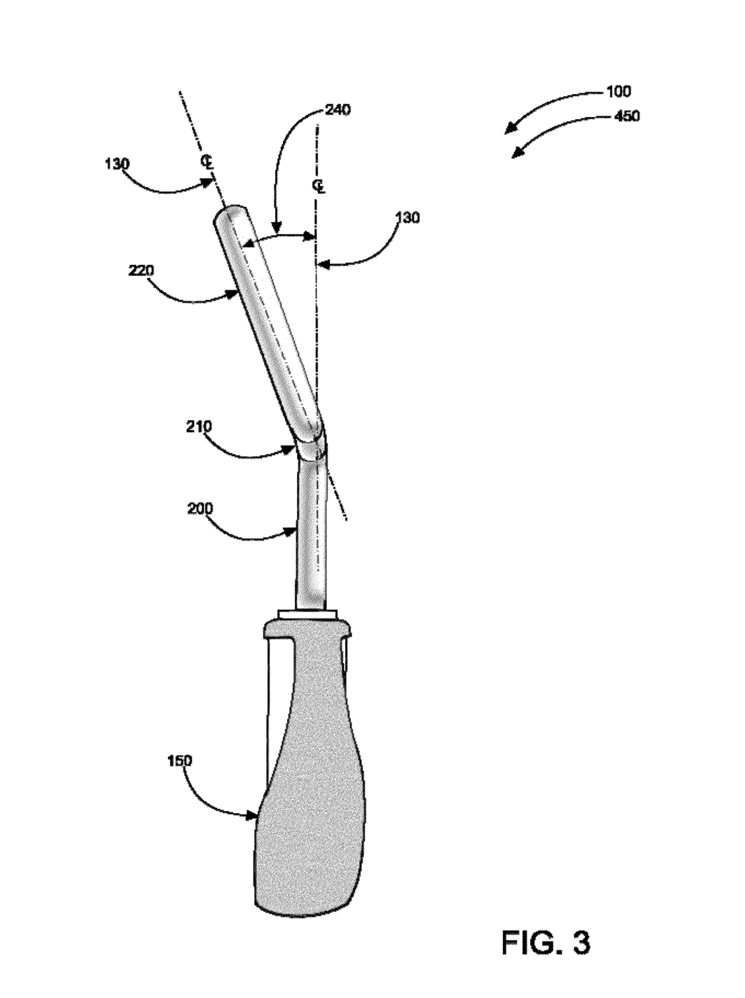

Bead bender tool 102 of the present embodiment may comprise handle 150 having centerline 130 (illustrated in FIG. 3) and shank 140. Handle 150 is preferably non-removably attached to shank 140 which may comprise at least one first 90 degree bend 160 and second 90 degree bend 170, wherein shank 140 extends from handle 150 along centerline 130 up to first 90 degree bend 160. First 90 degree bend 160 and second 90 degree bend 170 are orientated to form Z-shape profile 180 which may comprise at least one compound bend. Bead bender tool 102, as such is usable to spread apart tire beads 110 to allow for the removal and installation of a rim lock, inner tube, and valve stem during a cycle tire 120 change or repair via user manipulation such as that shown in FIG. 1.

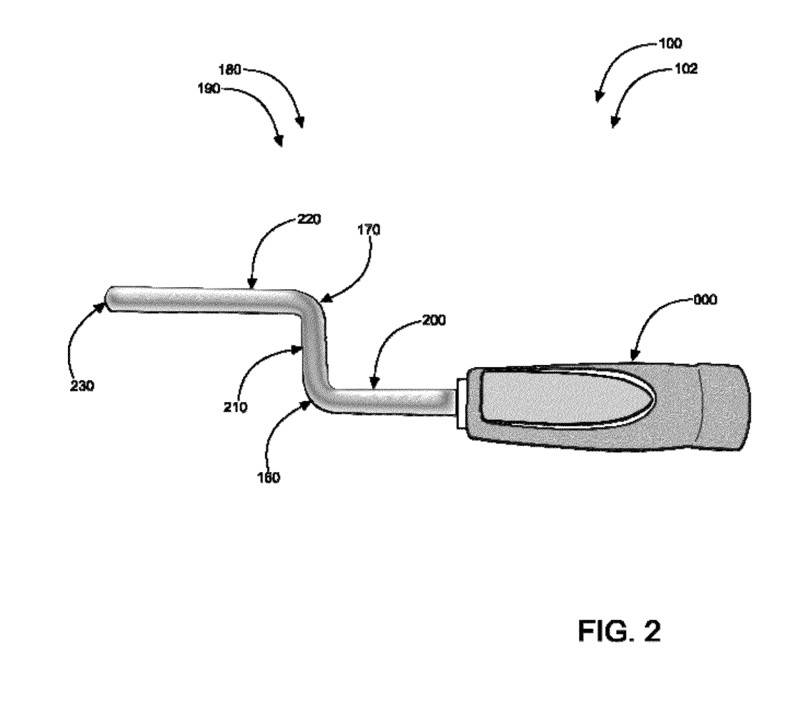

Referring now to FIG. 2, a side perspective view illustrating bead bender systems 100 according to an embodiment of the present invention of FIG. 1. Shank 140 may have a diameter of approximately ¼″ or 5/16″ in preferred embodiments (alternately more or less than in other versions.) The (overall) length of shank 140 may be approximately 13″ including handle 150. Shank 140, as shown, comprises Z-shape profile 180 and runs straight for approximately 4″, followed by first 90 degree bend 160, a 2″ straight section, and then second 90 degree bend 170 angled in the opposite direction for another 7″. A (screwdriver-type) handle 150 may be installed on the (lengthier) end of shank 140. Compound bend(s) 190 comprising first 90 degree bend 160 and second 90 degree bend 170 are orientated off-set parallel to each other. First 90 degree bend 160 of shank 140 is perpendicularly-oriented relative to centerline 130 of handle 150. Second 90 degree bend 170 of shank 140 is perpendicularly-oriented and 20 degrees relative to centerline 130 of handle 150, as best illustrated in FIG. 3.

Referring now to FIG. 3, a top perspective view illustrating bead bender tool 102 according to an embodiment of the present invention of FIG. 1. Shank 140 to first 90 degree bend 160 comprises first shank-portion 200. Shank 140 between first 90 degree bend 160 and second 90 degree bend 170 comprises second shank-portion 210. Shank 140 between second 90 degree bend 170 and end of shank 140 comprises third shank-portion 220 which preferably comprises rounded end-tip 230. The (shorter) end of shank 140 may be rounded so it can more easily ‘roll’ into position. First 90 degree bend 160 may have an additional 25 degree (more or less in alternate embodiments) bend 240 in it or may be planar with first shank-portion 200 and second 90 degree bend 170 may comprise about a 25 degree bend 240. Shank 140 has a shank-centerline (shown on third shank-portion 220) for use in relative reference to centerline of handle 150. Bead bender tool 102 may be inserted between tire 120 and rim 125. The user may then twist up, spreading tire beads 110 apart thus allowing for ease of access.

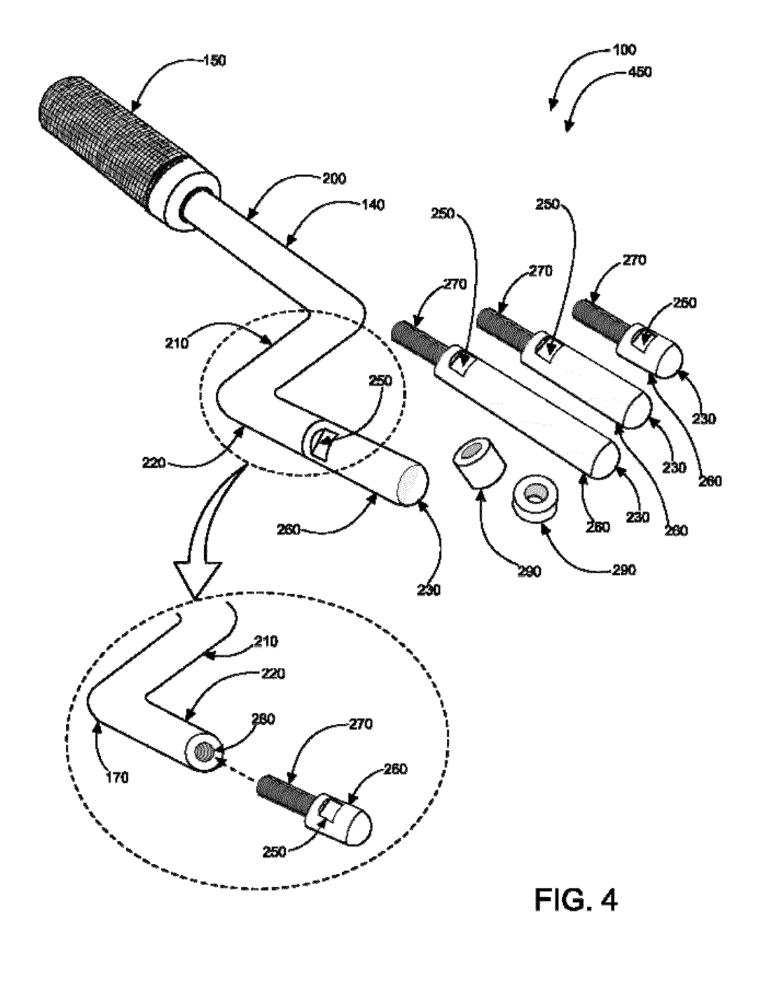

Referring now to FIG. 4, a perspective view illustrating a preferred version of bead bender systems 100 according to an embodiment of the present invention of FIG. 1. Bead bender tool 102 may comprise at least one removable fourth shank-portion 260 (threadingly attached to third shank-portion 220). Removable fourth shank-portion 260 preferably comprises milled tool-keyway 250 whereby a wrench may be used to remove removable fourth shank-portion 260 from a coupled relationship with third shank-portion 220 (to uncouple for changing out ends or for storage.) Removable fourth shank-portion(s) 260 comprise threaded stud 270 in this particular embodiment (or other suitable fastening means in other versions). Third shank-portion 220 comprises threaded bore 280 for receiving threaded stud 270 to facilitate use of removable fourth shank-portion 260.

Bead bender systems 100 may comprise multiple fourth shank-portions 260 which may include sizes/lengths from about 4 inches long, 3 inches long, 2 inches long, and 1 inch long. In another embodiment of the present invention, bead bender system 100 is preferably made of aluminum round stock material ½″ in diameter. The length of bead bender tool 102 is approximately 8¼″ long including handle 150 (excluding removable fourth shank-portions 260 third shank-portion 220) for use on different sizes of tire(s) 120. Handle 150 is preferably about 3½″ long and about 1″ in diameter with a knurled aluminum grip welded to shank 140. Shank 140 is Z-shaped (as in other embodiments) and runs straight from handle 150 for approximately 3″, followed by first 90 degree bend 160, then a 1¾″ straight section followed by second 90 degree bend 170 in the opposite direction with 25 degree bend 240, ending with a straight section 1½″ long.

Third shank-portion 220 is drilled and tapped for a thread size of approximately ¼″ thread for various sized removable fourth shank-portions 260. There may be 4 different length removable fourth shank-portions 260 and 2 different length spacers 290 (bushings or other suitable equivalent) that may be placed between third shank-portion 220 and removable fourth shank-portion 260 (to adjust length and make for ease of removal after use.) The length of removable fourth shank-portions 260 may be ¾″, 1½″, 1¾″ and 2½″ long (not including threaded stud 270.) Threaded stud 270 is for use in threadably inserting removable fourth shank-portion 260 into third shank-portion 220. These adapters may also be made of ½″ aluminum round stock that comprise rounded end-tip 230 on the end opposite threaded stud 270. Removable fourth shank-portions 260 may have tool-keyways 250 milled into them near threaded stud 270 to fit approximately a ⅜″ wrench for convenience of tightening removable fourth shank-portion 260 into shank 140. Spacers 290 may be made of aluminum round stock ½″ in diameter. The length of the spacers may be ⅜″ and ¼″ long. Spacers 290 may be bushings and preferably have through-holes through the center length-wise. The through-hole size is preferably slightly larger than ¼″ in diameter.

Bead bender system 100 may be sold as kit 450 comprising the following parts: at least one bead bender tool 102 (having handle 150; shank 140 (having at least first shank-portion 200, second shank-portion 210 and third shank-portion 220 with removable fourth shank-portion 260 in certain embodiments); at least one spacer 290 (wherein spacers 290 are used for additional length adjustment of removable fourth shank-portion 260 to third shank-portion 220); at least one removable fourth shank-portion 260 which is about 4 inches long; at least one removable fourth shank-portion 260 is about 3 inches long; at least one removable fourth shank-portion 260 is about 2 inches long; and at least one removable fourth shank-portion 260 being about 1 inch long. Removable fourth shank-portions 260 are suitable for manipulating tire bead 110 on various width tires 120. The kit may further comprise at least one set of user instructions.

Bead bender systems 100 may be manufactured and provided for sale in a wide variety of sizes, shapes, lengths, widths, and (shank to handle) orientations for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, parts may be sold separately, etc., may be sufficient.

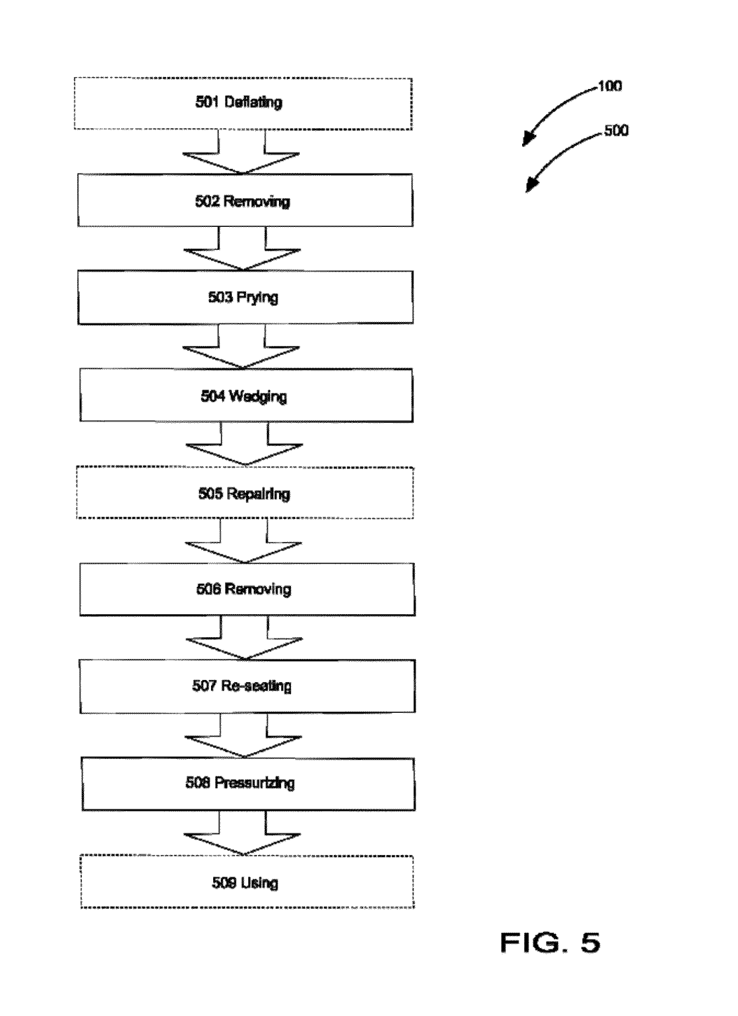

Referring now to FIG. 5, showing a flowchart illustrating method of use 500 according to an embodiment of the present invention of FIGS. 1-4. Method of use 500 for bead bender systems 100 may comprise the steps of: step one 501 deflating pneumatic tire 120; step two 502 removing valve core; step three 503 prying tire bead 110 over rim 125 outer edge; step four 504 wedging open tire 120 with bead bender tool 102; step five 505 repairing tire 120; step six 506 removing bead bender tool 102 from confines of tire 120; step seven 507 reseating tire bead 110 on rim 125; step eight 508 pressurizing tire 120 and step nine 509 using tire 120.

It should be noted that steps 501, 505, and 509 are optional steps and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A bead bender tool comprising:
a handle having a centerline;
a shank;
wherein said handle is non-removably attached to said shank;
wherein said shank comprises at least a first 90 degree bend and a second 90 degree bend;
wherein said shank extends from said handle along said centerline up to said first 90 degree bend;
wherein said first 90 degree bend and said second 90 degree bend are orientated to form a Z-shape profile in relation to said handle; and
wherein said bead bender tool comprising said first 90 degree bend and said second 90 degree bend is usable to spread apart and hold a tire bead to allow for the removal and installation of a rim lock, inner tube, and valve stem during a cycle tire change or repair.

2. The bead bender tool of claim 1 wherein said Z-shaped profile comprises at least one compound bend.

3. The bead bender tool of claim 2 wherein said compound bend of said first 90 degree bend and said second 90 degree bend are orientated off-set parallel to each other.

4. The bead bender tool of claim 2 wherein said compound bend of said first 90 degree bend and said second 90 degree bend are orientated are off-set non-parallel to each other.

5. The bead bender tool of claim 1 wherein said first 90 degree bend of said shank is perpendicularly-oriented relative to said centerline of said handle.

6. The bead bender tool of claim 1 wherein said second 90 degree bend of said shank is perpendicularly-oriented about 25 degrees relative to said centerline of said handle.

7. The bead bender tool of claim 1 wherein said shank to said first 90 degree bend comprises a first shank-portion.

8. The bead bender tool of claim 1 wherein said shank between said first 90 degree bend and said second 90 degree bend comprises a second shank-portion.

9. The bead bender tool of claim 1 further comprises a rounded end-tip.

10. The bead bender tool of claim 9 wherein said shank between said second 90 degree bend and said rounded end-tip comprises a third shank-portion.

11. The bead bender tool of claim 10 wherein said third shank-portion comprises at least one removable fourth shank-portion.

12. The bead bender tool of claim 11 wherein said removable fourth shank-portion comprises a milled tool-keyway whereby a wrench may be used to remove said removable fourth shank-portion from a coupled relationship with said third shank-portion.

13. The bead bender tool of claim 12 wherein said at least one removable fourth shank-portion comprises a threaded stud.

14. The bead bender tool of claim 13 wherein said third shank-portion comprises a threaded bore for receiving said threaded stud on said at least one removable fourth shank-portion.

15. The bead bender tool of claim 11 wherein said at least one removable fourth shank-portion is about 4 inches long.

16. The bead bender tool of claim 11 wherein said at least one removable fourth shank-portion is about 3 inches long.

17. The bead bender tool of claim 11 wherein said at least one removable fourth shank-portion is about 2 inches long.

18. The bead bender tool of claim 11 wherein said at least one removable fourth shank-portion is about 1 inch long.

19. A bead bender tool comprising:
a handle having a centerline;
a shank with a rounded end-tip;
wherein said handle is non-removably attached to said shank;
wherein said Z-shaped profile comprises at least one compound bend;
wherein said shank comprises at least a first 90 degree bend and a second 90 degree bend;
wherein said shank extends from said handle along said centerline up to said first 90 degree bend;
wherein said first 90 degree bend and said second 90 degree bend are orientated to form a Z-shape profile;
wherein said compound bend of said first 90 degree bend and said second 90 degree bend are orientated are off-set parallel to each other;
wherein said first 90 degree bend of said shank is perpendicularly-oriented relative to said centerline of said handle;
wherein said second 90 degree bend of said shank is perpendicularly-oriented about 20-25 degrees relative to said centerline of said handle;
wherein said shank to said first 90 degree bend comprises a first shank-portion;
wherein said shank between said first 90 degree bend and said second 90 degree bend comprises a second shank-portion;
wherein said shank between said second 90 degree bend and said rounded end-tip comprises a third shank-portion;
wherein said third shank-portion comprises at least one removable fourth shank-portion;
wherein said removable fourth shank-portion comprises a milled tool-keyway whereby a wrench may be used to uncouple and/or couple said removable fourth shank-portion from a coupled relationship with said third shank-portion;
wherein said at least one removable fourth shank-portion comprises a threaded stud;
wherein said third shank-portion comprises a threaded bore for receiving said threaded stud on said at least one removable fourth shank-portion;
wherein said at least one removable fourth shank-portion is between about 1 inch to about 4 inches long; and
wherein said bead bender tool is usable to spread apart a tire bead to allow for the removal and installation of a rim lock, inner tube, and valve stem during a cycle tire change or repair.

20. A bead bender tool kit comprising:
a bead bender tool having at least one handle and at least one shank;
at least one removable fourth shank-portion which is about 4 inches long; at least one removable fourth shank-portion which is about 3 inches long; at least one removable fourth shank-portion which is about 2 inches long; and at least one removable fourth shank-portion which is about 1 inch long;
at least one bushing; and
a set of user instructions.
